(19) United States
(12) Patent Application Publication
(10) Pub. No.: US 2016/0351887 A1
(43) Pub. Date: Dec. 1, 2016

(54) NONAQUEOUS ELECTROLYTE SECONDARY BATTERY

(71) Applicant: SANYO ELECTRIC CO., LTD., Daito-shi (JP)

(72) Inventors: Yuu Takanashi, Hyogo (JP); Kazuhiro Hasegawa, Hyogo (JP); Sho Tsuruta, Hyogo (JP); Atsushi Fukui, Hyogo (JP)

(73) Assignee: SANYO Electric Co., Ltd., Daito-shi (JP)

(21) Appl. No.: 15/117,304

(22) PCT Filed: Jan. 27, 2015
(86) PCT No.: PCT/JP2015/000339

§ 371 Date: Aug. 8, 2016

(30) Foreign Application Priority Data
Feb. 10, 2014 (JP) 2014-022965

(51) Int. Cl. H01M 4/131; H01M 4/525; H01M 4/505; H01M 10/0587; H01M 4/62; H01M 10/0525; H01M 10/0569; H01M 10/0568; H01M 4/36; H01M 4/66

(52) U.S. Cl. CPC H01M 4/131; H01M 4/366; H01M 4/525; H01M 4/505; H01M 4/661; H01M 4/625; H01M 4/623; H01M 10/0525; H01M 10/0569; H01M 10/0568; H01M 10/0587; H01M 2300/0034; H01M 2300/0037

(57) ABSTRACT

Provided is a nonaqueous electrolyte secondary battery which is capable of achieving high capacity and long life by suppressing the structural change of a positive electrode active material at high voltage. The nonaqueous electrolyte secondary battery includes a positive electrode containing a positive electrode active material storing and releasing lithium ions, a negative electrode containing a negative electrode active material storing and releasing lithium ions, and a nonaqueous electrolyte. The positive electrode active material is a lithium-cobalt composite oxide containing nickel, manganese, and aluminium and has a rare-earth compound or oxide deposited to a portion of the surface thereof.

### TECHNICAL FIELD

The present invention relates to a nonaqueous electrolyte secondary battery.

### BACKGROUND ART

Nonaqueous electrolyte secondary batteries typified by lithium ion batteries are widely used as driving power supplies for portable electronic devices such as mobile phones including smartphones, mobile computers, PDAs, and portable music players. Furthermore, the nonaqueous electrolyte secondary batteries have become widely used in driving power supplies for electric vehicles and hybrid electric vehicles and stationary storage battery systems for applications for suppressing output fluctuations in solar power generation, wind power generation, and the like and peak shift applications for grid power for the purpose of storing electricity during nighttime to use electricity during daytime.

However, the improvement of applied devices tends to further increase power consumptions; hence, a further increase in capacity is strongly required. Examples of a method for increasing the capacity of a nonaqueous electrolyte secondary battery include a method for increasing the capacity of an active material, a method for increasing the filling amount of an active material per unit volume, and a method for increasing the charge voltage of a battery. However, in the case of increasing the charge voltage of a battery, the crystal structure of a positive electrode active material is likely to be deteriorated or the positive electrode active material and a nonaqueous electrolyte solution are likely to react with each other.

Therefore, Patent Literature 1 proposes that cycle characteristics at a cut-off voltage of 4.4 V versus carbon and battery swelling at 4.2 V under a high-temperature atmosphere (60° C., 20 days) are improved in such a manner that lithium cobaltate and lithium nickelate are mixed together and cobalt or nickel is partially substituted with nickel, manganese, aluminium, or the like.

Patent Literature 2 proposes that battery swelling at 4.25 V to 4.5 V versus carbon under a high-temperature atmosphere (60° C., 30 days) and room-temperature cycles are improved in such a manner that lithium cobaltate is used as a main positive electrode active material, the positive electrode active material is substituted with aluminium by 0.02 mol to 0.04 mol in a molar ratio and is further substituted with one or more of nickel, manganese, and magnesium.

Patent Literature 3 proposes that cycle characteristics at 4.2 V versus carbon are improved in such a manner that the reaction of an active material with a nonaqueous electrolyte solution is suppressed by surface-coating a positive electrode active material with a compound.

### CITATION LIST

### Patent Literature

PTL 1: Japanese Published Unexamined Patent Application No. 2007-265731

PTL 2: Japanese Published Unexamined Patent Application No. 2007-273427

PTL 3: International Publication No. WO 2012/099265

### SUMMARY OF INVENTION

### Technical Problem

However, in the case where the voltage of a positive electrode is increased to more than 4.5 V versus lithium by raising the charge voltage, the surface and internal crystal structures of a positive electrode active material are transformed from an O3 structure to a H1-3 structure and an oxidizing atmosphere on a surface of the positive electrode is enhanced. Therefore, an electrolyte solution is oxidatively degraded, whereby cycle characteristics are reduced. Furthermore, the degradation of the electrolyte solution is more accelerated in high-temperature cycles than room-temperature cycles, whereby the cycle characteristics are further reduced. None of the above patent literatures describes the evaluation of cycle characteristics at high temperature in the case where the voltage of a positive electrode is increased to more than 4.4 V versus carbon. In Patent Literatures 1 and 2, lithium cobaltate is partially substituted with another element, whereby phase transition may possibly be suppressed in the positive electrode. However, the degradation of the electrolyte solution may possibly proceeds. Furthermore, in Patent Literature 3, internal phase transition may possibly proceeds when the voltage of a battery is high.

### Solution to Problem

A nonaqueous electrolyte secondary battery according to an aspect of the present invention includes a positive electrode containing a positive electrode active material storing and releasing lithium ions, a negative electrode containing a negative electrode active material storing and releasing lithium ions, and a nonaqueous electrolyte. The positive electrode active material is a lithium-cobalt composite oxide containing nickel, manganese, and aluminium and has a rare-earth compound or oxide deposited to a portion of the surface thereof.

(Positive Electrode Active Material)

In the present invention, the positive electrode active material can be represented by the formula LiCoₐNi_{b}Mn_{c}Al_{d}Al_{d}M1ₑO₂ (M1=Si, Ti, Ga, Ge, Ru, Pb, Sn). In particular, it is preferable that M1=Ge. Germanium is present on the surface of an active material to function as a protective film for the positive electrode and therefore can prevent a reaction with an electrolyte solution.

Cobalt in the lithium-cobalt composite oxide is preferably partially substituted with nickel, manganese, and aluminium together. Partially substituting cobalt with nickel enables high capacity to be achieved. Furthermore, partially substituting cobalt with manganese and aluminium, which form a strong bond with oxygen, enables the phase transition from an O3 structure to an H1-3 structure to be suppressed even in the case where a large amount of lithium is eliminated during charge and discharge at 4.53 V or more.

In the above formula, a preferably satisfies 0.65≦a≦0.85. When a<0.65, the filling factor and discharge capacity of the positive electrode active material are low and high capacity cannot be achieved. When a>0.85, the effect of stabilizing the crystal structure during charge and discharge at 4.53 V or more is small and no cycle characteristics may possibly be improved.

In the above formula, b, c, and d preferably satisfy 0.65≦a≦0.85, 0.05≦b≦0.25, 0.03≦c≦0.05, and 0.005≦d≦0.02, respectively, and the molar ratios between transition metals are preferably 1≦Ni/Mn≦5, 10≦Ni/Al≦30, and 10≦(Ni+Mn)/Al≦20. The ranges of the molar ratios between the transition metals are regulated as described above and the proportion of nickel is set higher than that of manganese and aluminium. Therefore, the valence of nickel is higher than two, the cation mixing of nickel entering a lithium layer is reduced, and the diffusion rate of lithium ions is increased; hence, cycle characteristics are enhanced. Furthermore, since the proportion of nickel is high, trivalent nickel on the surface of the positive electrode active material reacts with the electrolyte solution in accordance with cycles to produce NiO, which probably forms a protective film for the positive electrode active material to prevent a reaction with the nonaqueous electrolyte solution.

The rare-earth compound or the oxide is preferably deposited to a portion of the surface of the positive electrode active material. Attaching fine particles of the rare-earth compound or the oxide to the surface of the positive electrode active material in a dispersed state enables the structural change of the positive electrode active material to be suppressed when a charge-discharge reaction is carried out at high potential. The reason for this is unclear and is probably that attaching the rare-earth compound or the oxide to the surface increases the reaction overvoltage during charge and enables the change in crystal structure due to phase transition to be reduced. The rare-earth compound preferably includes at least one selected from the group consisting of erbium hydroxide and erbium oxyhydroxide. The oxide preferably includes at least one selected from the group consisting of aluminium oxide, zirconium oxide, magnesium oxide, copper oxide, boron oxide, and lanthanum oxide.

(Negative Electrode Active Material)

In the present invention, the negative electrode active material used is preferably one capable of storing and releasing lithium. For example, metallic lithium, lithium alloys, carbon compounds, metal compounds, and the like can be cited. These negative electrode active materials may be used alone or in combination. Examples of the carbon compounds include carbon materials with a turbostratic structure and carbon materials such as natural graphite, synthetic graphite, and glassy carbon. These have a very little change in crystal structure due to charge or discharge, are capable of obtaining high charge/discharge capacity and good cycle characteristics, and therefore are preferable. In particular, graphite has high capacity, is capable of obtaining high energy density, and therefore is preferable. Metallic lithium and the lithium alloys are cited. The alloys have higher potential as compared to graphite and therefore the potential of a positive electrode is high when a battery is charged or discharged at the same voltage; hence, higher capacity can be expected. Examples of a metal in the alloys include tin, lead, magnesium, aluminium, boron, gallium, silicon, indium, zirconium, germanium, bismuth, and cadnium. In particular, at least one of silicon and tin is preferably contained. Silicon and tin have a large capacity to store and release lithium and are capable of obtaining high energy density.

Examples of a constituent element, other than tin, in a tin alloy include lead, magnesium, aluminium, boron, gallium, silicon, indium, zirconium, germanium, bismuth, and cadnium. An example of a constituent element, other than silicon, in a silicon alloy is at least one of tin, lead, magnesium, aluminium, boron, gallium, indium, zirconium, germanium, bismuth, and cadnium.

(Nonaqueous Electrolyte Solvent)

A solvent for the nonaqueous electrolyte, which is used in the present invention, is not particularly limited and may be one conventionally used in nonaqueous electrolyte secondary batteries. For example, cyclic carbonates, linear carbonates, esters, cyclic ethers, linear ethers, nitriles, amides, and the like are cited. Examples of the cyclic carbonates include ethylene carbonate, propylene carbonate, and butylene carbonate. Examples of linear carbonates include dimethyl carbonate, ethyl methyl carbonate, diethyl carbonate, methyl propyl carbonate, ethyl propyl carbonate, carbonate, and methyl isopropyl carbonate. Examples of the esters include methyl acetate, ethyl acetate, propyl acetate, methyl propionate, ethyl propionate, and γ-butyrolactone. Examples of the ethers include 1,3-dioxolane, 4-methyl-1,3-dioxolane, tetrahydrofuran, 2-methyltetrahydrofuran, propylene oxide, 1,2-butylene oxide, 1,4-dioxane, 1,3,5-trioxane, furan, 2-methylfuran, 1,8-cineol, and crown ethers. Examples of the linear ethers 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether. Examples of the nitriles include acetonitrile. Examples of the amides include dimethylformamide. In particular, those obtained by partially or entirely substituting hydrogen in these compounds with fluorine are preferable. Fluorination increases the oxidation resistance of the nonaqueous electrolyte and therefore the degradation of the nonaqueous electrolyte can be prevented even in a high-voltage state in which an oxidizing atmosphere on a surface of the positive electrode is high. These compounds may be used alone or in combination. In particular, a solvent which is a combination of a cyclic carbonate and a linear carbonate is preferable.

(Electrolyte Salt)

A lithium salt added to the nonaqueous electrolyte may be one generally used in conventional nonaqueous electrolyte secondary batteries as an electrolyte. Examples of the lithium salt include LiPF₆, LiBF₄, LiAsF₆, LiClO₄, LiCF₃SO₃, LiN(FSO₂)₂, LiN(ClF₂ₗ₊₁SO₂)(CmF₂ₘ₊₁SO₂) (where l and m are integers greater than or equal to 1), LiC(CpF₂ₚ₊₁SO₂)(CqF_{2q+1}SO₂) (CrF₂ᵣ₊₁SO₂) (where p, q, and r are integers greater than or equal to 1), Li[B(C₂O₄)F₂] (lithium bis (oxalate) borate (LiBOB), Li[B(C₂O₄)F₂], Li[P(C₂O₄)F₄], and Li[P(C₂O₄)₂F₂]. These lithium salts may be used alone or in combination.

### Advantageous Effects of Invention

In accordance with a nonaqueous electrolyte secondary battery according to an aspect of the present invention, the following battery can be obtained: a long-life nonaqueous electrolyte secondary battery in which the structural change of a positive electrode active material and a reaction with an electrolyte solution on the surface of an active material can be suppressed at a very high charge voltage of 4.6 V versus lithium and high temperature (45° C.).

### BRIEF DESCRIPTION OF DRAWINGS

FIG. 1 is a SEM image of a positive electrode active material having a rare-earth compound deposited to the surface thereof.

FIG. 2 is a perspective view of a laminate-type nonaqueous electrolyte secondary battery according to an embodiment.

FIG. 3 is a perspective view of a wound electrode assembly according to an embodiment.

### DESCRIPTION OF EMBODIMENTS

Embodiments of the present invention are described below in detail. The embodiments below are exemplified for the purpose of embodying the technical spirit of the present invention. It is not intended to limit the present invention to the embodiments. The present invention is equally applicable to various modifications made without departing from the technical spirit described in the claims. First of all, a detailed method for preparing a positive electrode is described.

### Experiment 1

### Example 1

### Preparation of Positive Electrode

A positive electrode active material was prepared as described below. Lithium carbonate was used as a lithium source. Cobalt tetroxide was used as a cobalt source. Nickel hydroxide, manganese oxide, and aluminium hydroxide were used as a nickel source, a manganese source, and an aluminium source, respectively, serving as cobalt-substituting element sources. After cobalt, nickel, manganese, and aluminium were dry-mixed at a molar ratio of 84:10:5:1, the mixture was mixed with lithium carbonate such that the molar ratio of lithium to a transition metal was 1:1. Powder was formed into a pellet. The pellet was fired at 900° C. for 24 hours in an air atmosphere, whereby the positive electrode active material was prepared.

Next, a rare-earth compound was deposited to the surface by a wet method as described below. With 3 liters of pure water, 1,000 g of the positive electrode active material was mixed, followed by stirring, whereby a suspension containing the positive electrode active material dispersed therein was prepared. A solution containing 1.85 g of erbium nitrate tetrahydrate serving as a rare-earth compound source was added to the suspension in such a manner that an aqueous solution of sodium hydroxide was added to the suspension such that the pH of the suspension was maintained at 9.

Incidentally, when the pH of the suspension is less than 9, erbium hydroxide and erbium oxyhydroxide are unlikely to be precipitated. When the pH of the suspension is greater than 9, the precipitation rate of these compounds is high and the dispersion of these compounds on the surface of the positive electrode active material is uneven.

Next, the suspension was suction-filtered, followed by water washing, whereby powder was obtained. The powder was dried at 120° C. and was then heat-treated at 300° C. for 5 hours, whereby a positive electrode active material powder in which erbium hydroxide was deposited to the surface of the positive electrode active material was obtained.

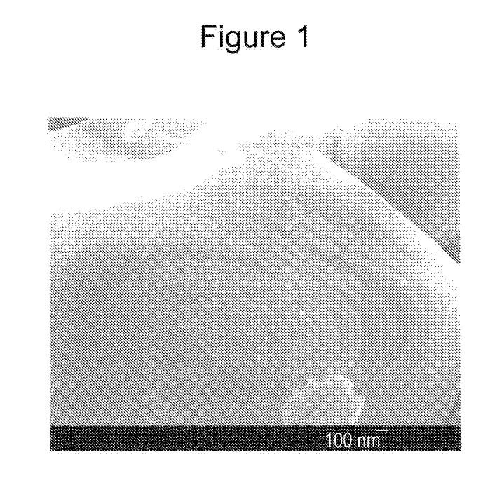

FIG. 1 shows a SEM image of the positive electrode active material having a rare-earth compound deposited to the surface thereof. It was confirmed that an erbium compound was deposited to the surface of the positive electrode active material in such a state that the erbium compound was evenly dispersed. The erbium compound had an average particle size of 100 nm or less. The amount of the deposited erbium compound was 0.07 parts by mass with respect to the positive electrode active material in terms of erbium as measured by inductively coupled high-frequency plasma emission spectrometry.

The following materials were mixed together: 96.5 parts by mass of the positive electrode active material, prepared as described above, having the rare-earth compound deposited to the surface thereof; 1.5 parts by mass acetylene black serving as a conductive agent; and 2.0 parts by mass of a polyvinylidene fluoride powder serving as a binding agent. The mixture was mixed with an N-methylpyrrolidone solution, whereby positive electrode mix slurry was prepared. Next, the positive electrode mix slurry was applied to both surfaces of 15 μm thick aluminium foil serving as a positive electrode current collector by a doctor blade process, whereby a positive electrode active material mix layer was formed on each of both surfaces of the positive electrode current collector. After being dried, the positive electrode active material mix layers were rolled using compaction rollers and were cut to a predetermined size, whereby a positive electrode plate was prepared. An aluminium tab serving as a positive electrode current-collecting tab was deposited to a portion of the positive electrode plate that was not covered by the positive electrode active material mix layers, whereby a positive electrode was prepared. The amount of the positive electrode active material mix layers was 39 mg/cm². The positive electrode mix layers had a thickness of 120 μm.

[Preparation of Negative Electrode Plate]

Graphite, carboxymethylcellulose serving as a thickening agent, and styrene-butadiene rubber serving as a binding agent were weighed at a mass ratio of 98:1:1 and were dispersed in water, whereby negative electrode mix slurry was prepared. The negative electrode mix slurry was applied to both surfaces of a negative electrode core, made of copper, having a thickness of 8 μm by a doctor blade process, followed by removing moisture by drying at 110° C., whereby negative electrode active material layers were formed. The negative electrode active material layers were rolled using compaction rollers and were cut to a predetermined size, whereby a negative electrode plate was prepared.

[Preparation of Nonaqueous Electrolyte Solution]

Fluoroethylene carbonate (FEC) and fluorinated propione carbonate (FMP) were prepared as nonaqueous solvents. FEC and FMP were mixed at a volume ratio of 20:80 at 25° C. Lithium hexafluorophosphate was dissolved in this nonaqueous solvent such that the concentration of lithium hexafluorophosphate was 1 mol/L, whereby a nonaqueous electrolyte was prepared.

[Preparation of Nonaqueous Electrolyte Secondary Battery]

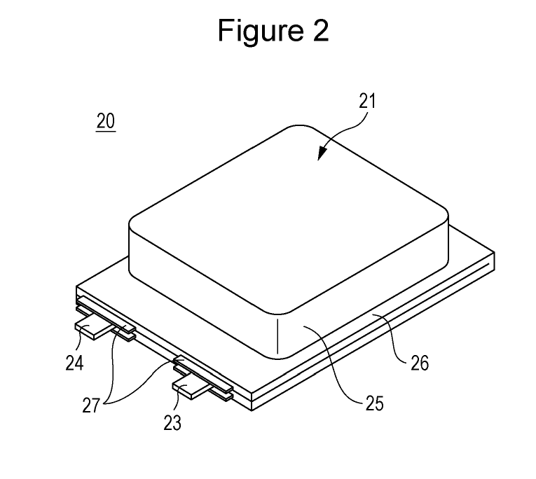

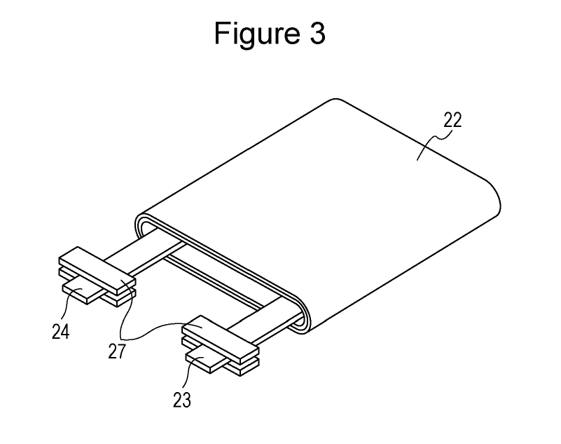

The evaluation of characteristics of a nonaqueous electrolyte secondary battery is described below. First, a method for manufacturing the nonaqueous electrolyte secondary battery is described with reference to FIGS. 2 and 3. A laminate-type nonaqueous electrolyte secondary battery 20 includes a laminate enclosure 21; a wound electrode assembly 22, flatly formed, including a positive electrode plate and a negative electrode plate; a positive electrode current-collecting tab 23 connected to the positive electrode plate; and a negative electrode current-collecting tab 24 connected to the negative electrode plate. The wound electrode assembly 22 includes the positive electrode plate, the negative electrode plate, and a separator, the positive electrode plate, the negative electrode plate, and the separator being strip-shaped. The positive electrode plate and the negative electrode plate are wound with the separator therebetween in such a state that the positive electrode plate and the negative electrode plate are insulated from each other with the separator.

The laminate enclosure 21 includes a recessed portion 25. One end side of the laminate enclosure 21 is bent so as to cover an opening of the recessed portion 25. An end portion 26 located around the recessed portion 25 is welded to a bent portion facing the end portion 26, whereby an inner portion of the laminate enclosure 21 is sealed. The wound electrode assembly 22 and a nonaqueous electrolyte solution are housed in the sealed inner portion of the laminate enclosure 21.

The positive electrode current-collecting tab 23 and the negative electrode current-collecting tab 24 are arranged to protrude from the laminate enclosure 21. The laminate enclosure 21 is sealed with a resin member 27. Electricity is supplied to the outside through the positive electrode current-collecting tab 23 and the negative electrode current-collecting tab 24. The resin member 27 is placed between the laminate enclosure 21 and each of the positive electrode current-collecting tab 23 and the negative electrode current-collecting tab 24 for the purpose of increasing the adhesion and the purpose of preventing a short circuit through an aluminium alloy layer in a laminate member.

Next, the prepared positive electrode and negative electrode plates were wound with a separator therebetween, the separator being composed of a microporous membrane made of polyethylene, followed by attaching a polypropylene tape to the outermost periphery, whereby a cylindrical wound electrode assembly was prepared. The cylindrical wound electrode assembly was pressed, whereby a flat wound electrode assembly was prepared. Next, the following member was prepared: a sheet-shaped laminate member having a five-layer structure consisting of a polypropylene resin layer, an adhesive agent layer, an aluminium alloy layer, an adhesive material layer, and a polypropylene resin layer. The laminate member was bent, whereby a bottom portion and a cup-shaped electrode assembly storage space were formed.

Next, the flat wound electrode assembly and the nonaqueous electrolyte were provided in the cup-shaped electrode assembly storage space in a glove box under an argon atmosphere. Thereafter, the separator was impregnated with the nonaqueous electrolyte by evacuating the inside of a laminate enclosure and an opening of the laminate enclosure was then sealed. In this way, Battery A1 having a height of 62 mm, a width of 35 mm, and a thickness of 3.6 mm (dimensions excluding a sealing portion) was prepared. In the case where the nonaqueous electrolyte secondary battery was charged to 4.50 V and was then discharged to 2.50 V, the discharge capacity thereof was 800 mAh.

### Example 2

Battery A2 was prepared in substantially the same manner as that described in Example 1 except that a positive electrode active material was prepared such that the molar ratio of cobalt to nickel to manganese to aluminium was 79:15:5:1.

### Example 3

Battery A3 was prepared in substantially the same manner as that described in Example 1 except that a positive electrode active material was prepared such that the molar ratio of cobalt to nickel to manganese to aluminium was 68:25:5:2.

### Comparative Example 1

Battery B1 was prepared in substantially the same manner as that described in Example 1 except that a positive electrode active material was prepared such that the molar ratio of cobalt to nickel to manganese was 90:5:5.

### Comparative Example 2

Battery B2 was prepared in substantially the same manner as that described in Example 1 except that a positive electrode active material was prepared such that the molar ratio of cobalt to nickel to aluminium was 89:10:1.

### Comparative Example 3

Battery B3 was prepared in substantially the same manner as that described in Example 1 except that a positive electrode active material was prepared such that the molar ratio of cobalt to nickel was 90:10.

### Comparative Example 4

Battery B4 was prepared in substantially the same manner as that described in Example 1 except that a positive electrode active material was prepared such that the molar ratio of cobalt to manganese was 90:10.

### Comparative Example 5

Battery B5 was prepared in substantially the same manner as that described in Example 1 except that no rare-earth compound was deposited to the surface of a positive electrode active material.

[Conditions for Charge/Discharge Cycles]

The above-mentioned batteries were subjected to a charge/discharge test under conditions below.

Each battery was charged at a constant current of 400 mA until the voltage of the battery reached 4.50 V. After the battery voltage reached each value, the battery was charged at a constant voltage until the current reached 40 mA. The battery was discharged at a constant current of 800 mA until the battery voltage reached 2.50 V and the amount of electricity flowing in this operation was measured, whereby the first-cycle discharge capacity was determined. The potential of graphite used in a negative electrode is about 0.1 V versus lithium. Therefore, the potential of a positive electrode is about 4.53 V to 4.60 V versus lithium at a battery voltage of 4.50 V. Charge and discharge were repeated under the same conditions as the above, the 100th-cycle discharge capacity was measured, and the capacity retention was calculated using an equation below. The measurement temperature was 45° C.

Capacity retention (%)−(100th-cycle discharge capacity/first-cycle discharge capacity)×100

Results are shown in Table 1.

TABLE 1

| | | | | | | | | Presence or | |
|---|---|---|---|---|---|---|---|---|---|
| | | | | | | | | Absence of | 100th-cycle |
| | Content/mole percent | | | | Molar ratio | | | Deposited | capacity |
| | Co | Ni | Mn | Al | Ni/Mn | Ni/Al | (Ni + Mn)/Al | compound | retention/% |
| A1 | 84 | 10 | 5 | 1 | 2 | 10 | 15 | Present | 90 |
| A2 | 79 | 15 | 5 | 1 | 3 | 15 | 20 | Present | 90 |
| A3 | 68 | 25 | 5 | 2 | 5 | 13 | 15 | Present | 90 |
| B1 | 90 | 5 | 5 | 0 | 1 | | | Present | 90 |
| B2 | 89 | 10 | 0 | 1 | | 10 | 10 | Present | 90 |
| B3 | 90 | 10 | 0 | 0 | | | | Present | 54 |
| B4 | 90 | 0 | 10 | 0 | 0 | | | Present | 58 |
| B5 | 84 | 10 | 5 | 1 | 2 | 10 | 15 | Absent | 58 |

In comparisons between results of Batteries A1 to A3 and B1 to B4, Batteries A1 to A3 have a capacity retention of 88% or more and Batteries B1 to B4 have a capacity retention of 81% or less. Batteries A1 to A3 contain all of nickel, manganese, and aluminium, which serve as cobalt-substituting element sources. However, Batteries B1 to B4 lack any one of nickel, manganese, and aluminium. From these results, it is conceivable that when nickel, manganese, and aluminium are contained in a lithium-cobalt composite oxide, the reduction of cycle characteristics is suppressed because the internal structure and surface structure of an active material are stabilized and therefore the degradation of an electrolyte solution is suppressed.

In a comparison between Batteries A1 and B5, it is clear that the reduction of cycle characteristics cannot be suppressed using a positive electrode active material containing a lithium-cobalt composite oxide containing nickel, manganese, and aluminium when the positive electrode active material has no rare-earth compound deposited thereto.

### Experiment 2

### Example 4

Battery A4 was prepared in substantially the same manner as that described in Example 1 except that no erbium compound was deposited to the surface of a positive electrode active material and boron oxide was deposited thereto as described below.

[Method for Attaching Boron Oxide]

The positive electrode active material was dry-mixed with 0.5% by mass of B₂O₃ with respect to the positive electrode active material, followed by heat treatment at 300° C. for 5 hours, whereby the positive electrode active material having B₂O₃ deposited to the surface thereof was obtained.

### Example 4

Battery A5 was prepared in substantially the same manner as that described in Example 1 except that no erbium compound was deposited to the surface of a positive electrode active material and lanthanum oxide was deposited thereto as described below.

[Method for Attaching Lanthanum Oxide]

The positive electrode active material was dry-mixed with 0.5% by mass of La₂O₃ with respect to the positive electrode active material, followed by heat treatment at 300° C. for 5 hours, whereby the positive electrode active material having La₂O₃ deposited to the surface thereof was obtained.

[Conditions for Charge/Discharge Cycles]

The 100th-cycle capacity retention was determined under the same conditions as those described in Experiment 1. Results are shown in Table 2.

TABLE 2

| | Content/mole percent | | | | Type of deposited | 100th-cycle capacity |
|---|---|---|---|---|---|---|
| | Co | Ni | Mn | Al | compound | retention/% |
| A1 | 84 | 10 | 5 | 1 | Erbium compound | 90 |
| A4 | 84 | 10 | 5 | 1 | B₂O₃ | 82 |
| A5 | 84 | 10 | 5 | 1 | La₂O₃ | 87 |
| B5 | 84 | 10 | 5 | 1 | Not used | 58 |

In comparisons between Batteries A1, A4, A5, and B5, Batteries A1, A4, and A5 have a capacity retention of 80% or more and Battery B5 has a capacity retention of 58%. In Batteries A1, A4, and A5, a rare-earth compound or an oxide is deposited to the surface of a positive electrode active material. However, in Battery B5, no deposited substance is present on the surface of a positive electrode active material. From these results, it is conceivable that attaching the rare-earth compound or the oxide to a portion of the surface of the positive electrode active material increases the reaction overvoltage during charge when a charge-discharge reaction is carried out at a high potential to suppress the change in crystal structure of the positive electrode active material due to phase transition.

A laminate-type nonaqueous electrolyte secondary battery has been exemplified. The present invention is not limited to this battery and is applicable to cylindrical nonaqueous electrolyte secondary batteries, rectangular nonaqueous electrolyte secondary batteries, and similar batteries including an enclosure can made of metal.

### INDUSTRIAL APPLICABILITY

A nonaqueous electrolyte secondary battery according to an aspect of the present invention is applicable to, for example, applications, such as mobile phones, notebook personal computers, smartphones, and tablet terminals, requiring particularly high capacity and long life.

### REFERENCE SIGNS LIST

20 Nonaqueous electrolyte secondary battery
21 Laminate enclosure
22 Wound electrode assembly
23 Positive electrode current-collecting tab
24 Negative electrode current-collecting tab

1. A nonaqueous electrolyte secondary battery comprising a positive electrode containing a positive electrode active material storing and releasing lithium ions, a negative electrode containing a negative electrode active material storing and releasing lithium ions, and a nonaqueous electrolyte,
wherein the positive electrode active material is represented by the formula LiCoₐNi_{b}Mn_{c}Al_{d}MₑO₂ (M=Si, Ti, Ga, Ge, Ru, Pb, Sn) (0.65≦a≦0.85, 0.05≦b≦0.25, 0.03≦c≦0.05, 0.005≦d≦0.02, 0≦e≦0.02) and the molar ratios between transition metals are 1≦Ni/Mn≦5, 10≦Ni/Al≦30, and 10≦(Ni+Mn)/Al≦20, and on the surface of which particles of oxide or a rare earth compound are dispersed deposits.

2. (canceled)

3. The nonaqueous electrolyte secondary battery according to claim 1, wherein charge is performed such that the potential of the positive electrode is 4.53 V or more versus lithium.

4. The nonaqueous electrolyte secondary battery according to claim 1, wherein the particles comprising at least one of erbium hydroxide and erbium ox hydroxide.

5. The nonaqueous electrolyte secondary battery according to claim 1, wherein the particles comprising at least boron oxide or lanthanum oxide.

6. The nonaqueous electrolyte secondary battery according to claim 1, wherein the nonaqueous electrolyte contains a fluorinated solvent.

7. The nonaqueous electrolyte secondary battery according to claim 6, wherein the fluorinated solvent includes fluoroethylene carbonate, fluorinated methyl propionate, and fluorinated methyl ethyl carbonate.

8. The nonaqueous electrolyte secondary battery according to claim 5, wherein the particles comprising boron oxide.

9. The nonaqueous electrolyte secondary battery according to claim 5, wherein the particles comprising lanthanum oxide.
